(19) United States
(12) Patent Application Publication
(10) Pub. No.: US 2014/0213179 A1
(43) Pub. Date: Jul. 31, 2014

(54) System and Method for Establishing Communications between Two Devices

(71) Applicant: Einar Rosenberg, Miami, FL (US)

(72) Inventor: Einar Rosenberg, Miami, FL (US)

(21) Appl. No.: 14/167,974

(22) Filed: Jan. 29, 2014

Related U.S. Application Data
(60) Provisional application No. 61/758,269, filed on Jan. 29, 2013.

(51) Int. Cl. H04W 76/02; H04B 5/00; H04B 5/02

(52) U.S. Cl. CPC H04W 76/023; H04B 5/02; H04B 5/0031
USPC 455/41.1

(57) ABSTRACT

A method for wirelessly transferring files from a first electronic device to a second electronic device using an intermediary electronic device to separately wirelessly communicate with both electronic devices using close proximity communication.

### CROSS REFERENCE TO RELATED APPLICATION

This application claims the benefit of US. provisional patent application No. 61/758,269, filed Jan. 29, 2013, the disclosure of which is incorporated herein by reference in its entirety.

### BACKGROUND OF THE INVENTION

More and more people are taking and using their laptops out in public venues. People are enticed into settling into a venue, for example, a coffee house, having coffee and using their laptop to work or do personal business by virtue of the venue offering free Wi-Fi access for customers. However, for many reasons, especially because of undesirable persons (e.g., “freeloaders”) accessing a venue's Wi-Fi system, as of late there has been a movement by certain venues to put limits on who can access their Wi-Fi system. On one hand, venues don't want to make it too onerous for users to be able to access their Wi-Fi system, e.g., by having a complicated password to access the Wi-Fi system. On the other hand, if a venue utilizes a very simple password, then it is easy for undesirable persons to get and use the password. Hence, if the password is too complicated then it would likely decrease freeloaders access to the system, but legitimate users will have problems implementing it.

Further, some venues are now charging for Wi-Fi system access. In order to access these systems, a consumer must provide information and payment, however, consumers find it onerous to fill in a variety of personal and payment information, thereby limiting the venues ability to generate revenue from offering paid Additionally, weak password and undefined users on the network create many security vulnerabilities.

Today, beyond typing out the information, Near Field Communications (“NFC”) technology methods are allowing people to quickly pair their devices to either networks or other devices using Wi-Fi, Bluetooth, Wireless USB, and other connection channel technologies. In this approach, a user with an NFC enabled mobile phone uses the phone to retrieve a venue's “Wi-Fi password from a NFC device in the store. The phone is then physically carried to the larger more cumbersome device such as a laptop. The phone then gives the laptop the Wi-Fi access credentials it just received from the stores NFC device.

Beyond retail venues, we are now finding consumer electronics products such as TV's, Stereos, and other products incorporating NFC to allow pairing between devices. Yet the physical usability of NFC technology to enable is really designed for smaller devices, e.g., mobile phones. Larger devices such as Laptops, and other computing devices that are not as small as mobile phones, are being integrated with NFC. The larger devices can utilize this reasonably secure pairing, but due to their size, are too cumbersome to maneuver near a system's NFC device to easily enable NFC standard tap process for pairing and linking devices via NFC.

Additionally, the positioning of NFC devices can make NFC pairing unwieldy. For example, many laptops that are now incorporating NFC devices are placing them on the topside of the keyboard side of a laptop. Laptops are portable and may be relatively easy to carry but generally not very easy to maneuver—flip, turn, invert, rotate, etc. If, for example, an NFC device in a store is securely positioned, so that it will not “walk away”, it will likely be placed on a desk top surface or a wail. Thus, to pair the laptop to an NFC device, would require the user carrying the laptop to the store's NFC tag and then inverting the laptop so that the NFC device on the laptop is within a couple of inches of the NFC device.

As NFC now becomes mainstream and found in 100+s of millions of devices, it would be desirable for consumers to have a method of benefiting from NFC's pairing and linking technology, especially for larger devices, but without the physical cumbersomeness commensurate with carrying and manipulating a laptop computer to tap it to an NFC device/router at a venue or to an NFC Tag containing the connection information for that router, or any other large computing devices that now are able to connect and communicate with other localized devices such as your NFC Laptop with your NFC TV, or your NFC Tablet with your NFC Stereo, etc. While the technology of NFC pairing is sound and standardized, the usability in the real world is cumbersome. Therefore, it would be desirable to have a method and/or system to more easily enable NFC pairing with a cumbersome device.

### BRIEF DESCRIPTION OF THE DRAWINGS

FIG. 1 depicts a computing device seeking a wireless network connection to a second device that provides an Internet connection;

FIGS. 2(a)-(c) depict a computing device seeking a wireless network connection to a second device that provides an Internet connection in accordance to an exemplary embodiment;

FIG. 3 depicts a flow for using the transmission of a code in accordance with FIGS. 2(a)-(c);

FIGS. 4(a)-(b) and 5(a)-(b) depict an example of a computing device seeking a wireless network connection to a second device that provides an Internet connection in accordance to another exemplary embodiment;

FIG. 6 depicts a flow for using the transmission of a code in accordance with FIGS. 4(a)-(b) and 5(a)-(b);

FIGS. 7(a)-(c) depict a computing device seeking a wireless network connection to a second device that provides an Internet connection in accordance to an exemplary embodiment;

FIG. 8 depicts a flow for using the transmission of a code in accordance with FIGS. 7(a)-(c);

FIGS. 9(a)-(b) and 10(a)-(b) depict an example of a computing device seeking a wireless network connection to a second device in accordance to another exemplary embodiment

FIG. 11 depicts a flow for using the transmission of a code in accordance with FIGS. 9(a)-(b) and 10(a)-(b);

FIGS. 12(a)-(b) depict a computing device seeking a wireless network connection to a second device in accordance to an exemplary embodiment;

FIG. 13 depicts a flow for using the transmission of a code in accordance with FIG. 12(a)-(b);

FIGS. 14(a)-(b) and 15(a)-(b) depict a computing device seeking a wireless network connection to a second device in accordance to an exemplary embodiment; and

FIG. 16 depicts a flow for using the transmission of a code in, accordance with FIGS. 14(a)-(b) and 15(a)-(b).

### DETAILED DESCRIPTION OF THE INVENTION

In the following detailed description, reference is made to the accompanying drawings, which form a part hereof, and in which is shown by way of illustration specific exemplary embodiments of the invention. These embodiments are described in sufficient detail to enable those of ordinary skill in the art to make and use the invention, and it is to be understood that structural, logical, or other changes may be made to the specific embodiments disclosed without departing from the spirit and scope of the present invention.

The invention discloses a method for quickly and securely connecting a first computing device to a second computing device, using a third computing device as a “go-between.” The third computing device is preferably more portable and less cumbersome to manipulate than the first and/or second devices.

A conventional method of connecting a laptop computer to a venue's Wi-Fi system requires that a user get the wireless (or wired) connection settings, find the identification sequence, e.g., for example, Wi-Fi, the ssid of the network, then either the communication system is connected or it requires that a code, PIN, password, etc., be provided. A code is typically a very simple code that is an easily repeated one that is orally or given to patrons on paper. These scenarios allow for easy spoofing of networks and a very simplistic level of password security, if any at

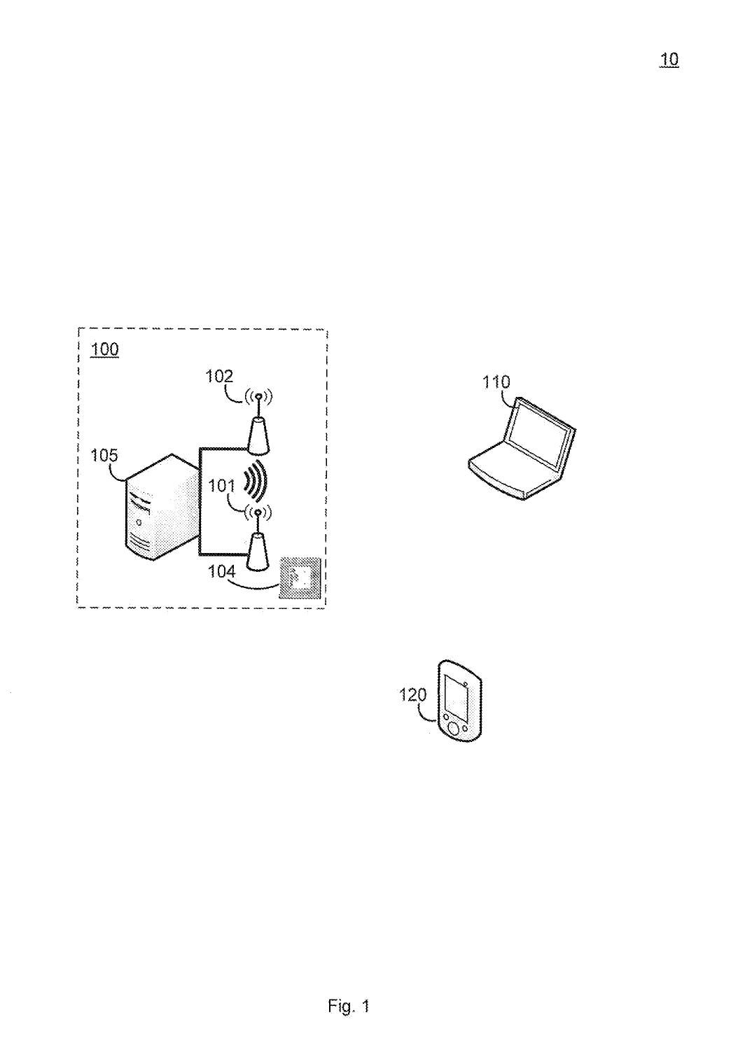

FIG. 1 depicts a computing device seeking a wireless network connection to a second device that provides an Internet connection in accordance with an exemplary embodiment of the invention. As depicted in FIG. 1, system 10 includes a computing device 110, e.g., a laptop computer, that is seeking a wireless connection to wireless network system 100. In an approach, system 100 includes a computing device 105 connected to the Internet (not shown for simplicity). System 100 also includes a wireless communication system 102, e.g., a router, for connecting to other wireless devices, and a Near Field Communications (NFC) system 101, e.g., an NFC access point, and/or NFC tag, e.g.,an NFC tag 104. Although an NFC access point, e g., an NFC reader, and an NFC have their different characteristics, for the most part in the descriptions that follow, the NFC 101 and NFC 104 urn be used interchangeably. Although system 100 is shown as including computing device 105, the system is not so limited and computing device 105 can be omitted where communication system 102 is a router being connected to the Internet. Also included in system 10, is a NFC enabled mobile communication device 120, e.g., a smart phone. Although not drawn to scale, system 100 is preferably not within close proximity of the laptop. For example, if NFC tag 104 is located at a restaurant service counter and the laptop is at a seating area, not within close proximity of NFC tag 104.

In an exemplary approach, an NFC device is used to provide an electronic file, e.g., a code, to the laptop from the system 100, and more specifically, from an NFC device 101/104. An NFC device, e.g., 101 or 104, inherently requires that the other NFC device that it is communicating with be within close proximity to the NFC device, typically within one to two inches. In this way, there is an inherent level of security by requiring the device seeking access to the Internet to be brought close to the NFC device. The NFC device would preferably be located central location within a venue, most likely under the direct/indirect purview of employees of the venue. The NFC device is used to provide a code, e.g., an electronic file that includes access information for the system, preferably a code that is not easily repeated orally or otherwise, as well as other connecting information. These codes can also be more (or less) complex and dynamic to each new user that tries linking or pairing to the first NFC enabled device which has the connection to the inter et

In the exemplary embodiment, all three devices are NFC enabled. NFC enablement can include, but is not limited to, having NFC embedded into the device, an NFC Tag placed on or near the device, or having an accessory that gives the device NFC capabilities. NFC communications are a preferred method in which the third device. The “intermediary device”, communicates with, the first device, and in which the second device communications with the third device. NFC is preferred, in part, due to an inherent security aspect, e.g., that two devices have to be in very close proximity, generally within one to two inches, in order to carry out communications. However, while this invention defines NFC as the linking technology between the three devices, other appropriate close proximity communication technologies, preferably communication systems that are predominately used in the short distance, can be substituted such as Bluetooth Low Energy, 2D Barcodes, Sonic, and other close proximity communication technologies. Non close proximity communications technologies are those technologies that enable communications over greater distances, e.g., over many meters. This invention offers a technology and method to still benefit from NFC's linking and pairing abilities while reducing the cumbersome physical process that could inhibit or restrict large NFC enabled devices from being able to pair and link.

However, if the NFC device, e.g., NFC tag 104 or NFC Reader 101, is located, for example, at the order desk of a McDonalds, it would be cumbersome and unwieldy to have a user bring their NFC enabled laptop, open and ready for communications, to the NFC device. In the exemplary approach of the invention, an NFC mobile communication device is used to retrieve the code from NFC enabled device 104/101, and provide it to the NFC enabled laptop computer 110. The computer 110 then uses the code to access the venue's Wi-Fi and, in turn, the Internet, through the device 102.

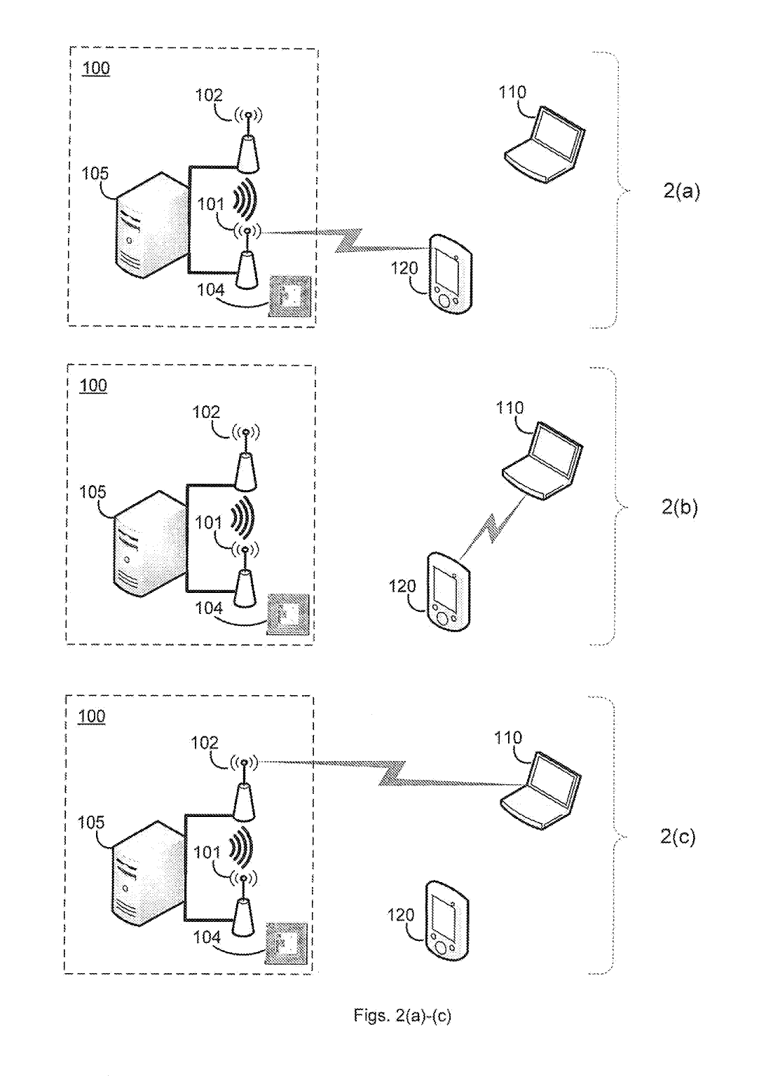

FIGS. 2 (a)-(c) depict a first computing device seeking a wireless network connection to or from a second device that provides an Internet connection in accordance to an exemplary embodiment. The mobile communication device 120 is used to provide a code, e.g., a password or access code, from the NFC device 101/104/105 to a laptop 110. If the venue's is “hidden”, the code also includes the name of the hidden wireless network.

In an exemplary approach, the mobile communication device 120 has downloaded and installed an appropriate app or an api running on a third party app, e.g., a “grab and drop app”, to enable the mobile communication device 120 to communicate with other devices described in the examples below. The functionality of a grab and drop app includes, but is not limited to, independently or in combination with other features and apps on the mobile communication device 120 on which the grab and drop app resides, to he able to communicate with other NFC enable devices and exchange information with the NFC enabled devices. The grab and drop app can also store information received from an NFC device and recall that information so that it can be provided to another NFC device.

Thus, FIG. 2(a) depicts a mobile communication device 120 that is running the grab and drop app establishing communications with the NFC device 101. The NFC device 101 stores, for example, a network code. After NFC communications are established between the devices, the NFC device 101 provides and the mobile communication device 120 receives a network code from the NFC device 101 for system 100. As noted above, although the example is described with respect to NFC device 101, NFC device 104 can be used in place of NFC device 101 in a similar fashion.

FIG. 2(b) depicts the mobile communication device 120 establishing NFC communications with the NFC laptop 110. After NFC communications are established, the mobile communication device 120 provides the network code, e.g., the code it received from NFC device 101, to the. laptop 110. In an approach, the network code also includes the ssid of the network connection.

FIG. 2(c) depicts the laptop 110 establishing communications with the wireless communication system 102. This is akin to a laptop accessing a local router or a network connection, but still lacks access to the Internet. The laptop 110 determines access information derived from said network code. After communications are established, the laptop 110 provides the access information contained in the network code that it received from the mobile communication device 120 to the communication system 102. This network code is the access code that permits the laptop 110 access to the Internet. Thereby, the network code enables the laptop 110 access to the Internet through the computer system 100. In alternative approach, the code is for access to the network connection, which in turn, enabling the laptop 110 access to the Internet through the network of the computer system 100. Therefore, the mobile communication device 120 retrieves the access code to the venue's Wi-Fi system from an NFC device 101/104 and provides the access code to the laptop 110, whereby the laptop 110 does not need to be in close proximity to the NFC device 101/104 to get the code.

In certain aspects, the network code is used to determine the access point, e.g., the computer system 100 for the laptop 110 to communicate with. Thus, the laptop 110 determines the contents of the access information to determine which computer system to attempt to communicate with.

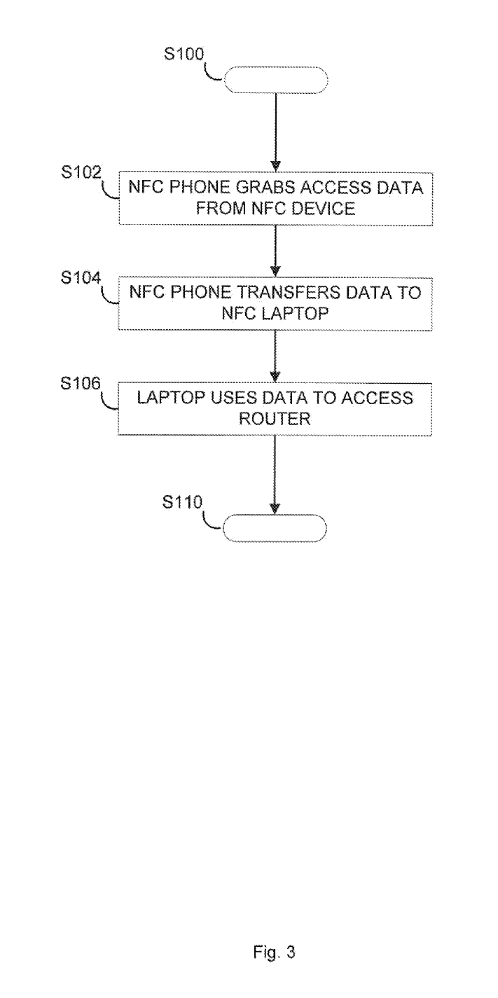

FIG. 3 is a flow chart depicting an exemplary process flow for using the transmission of a code from a first device to a second device by way of a third device. This process flow is based on an exemplary application of the system described with respect to FIGS. 2(a)-(c).

The process starts at S100 and proceeds to segment S102.

In segment S102, a mobile communication device 120 establishes communications with the NFC device 101. After NFC communications are established, the mobile communication device 120 receives a network code from the NFC device 101. Process continues to segment S104.

In segment S104, the mobile communication device 120 establishes communications with the NFC laptop 110. After NFC communications are established, the mobile communication device 120 provides the network code to the laptop 110. Process continues to segment S106.

In segment S106, the laptop 110 establishes communications with the wireless communication system 102. After communications are established, the laptop 110 provides the network code to the communication system 102. Process continues to segment S110.

In segment S110, the process is complete.

Thus, as noted above, the laptop 110 has access to the Internet though computer system 100.

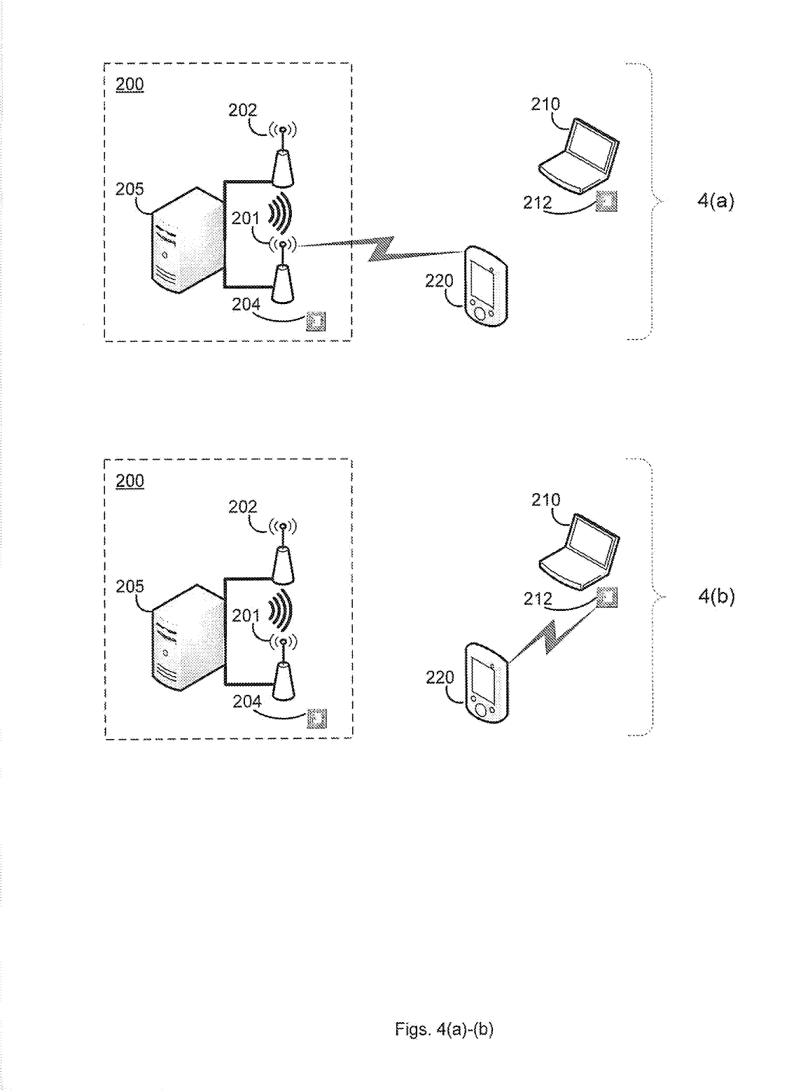

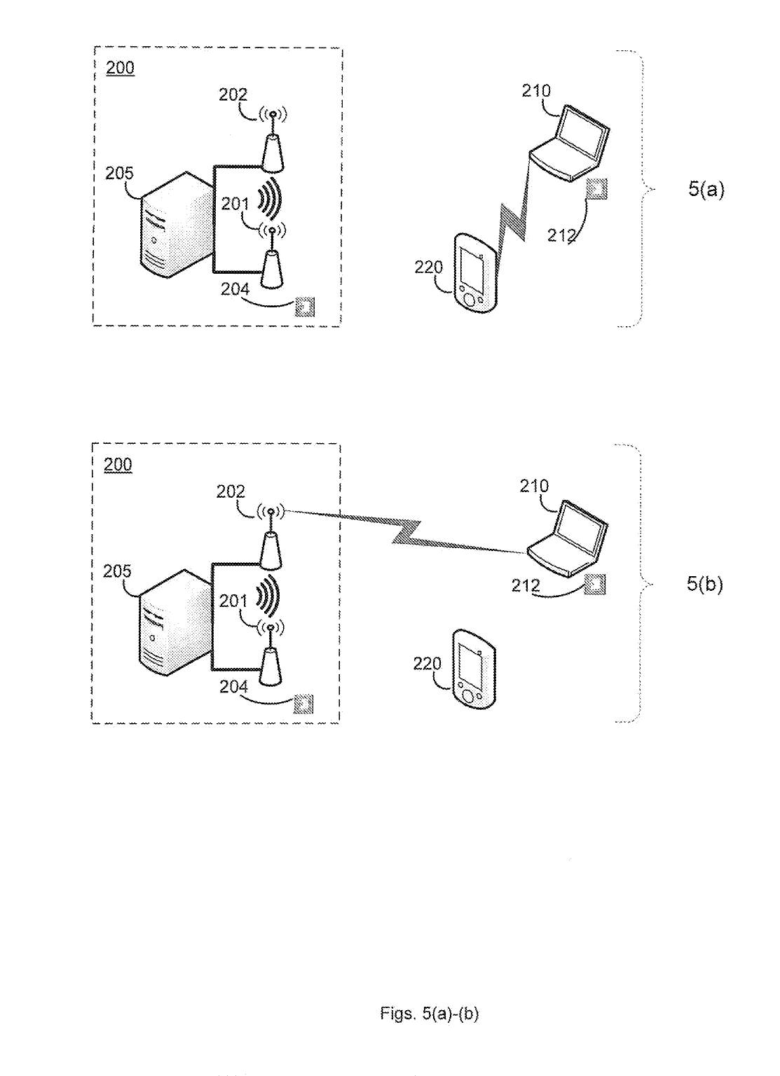

FIGS. 4 and 5 depict an example of a computing device seeking a wireless network connection to a second device that provides an Internet connection in accordance to an another exemplary embodiment.

As depicted in FIG. 4(a) a computing device 210, e.g., a laptop computer, is seeking connection to wireless network system 200. In an approach, system 200 includes a computing device 205 connected to the Internet (not shown for simplicity). System 200 also includes a wireless communication system 202, e.g., a router, for connecting to other wireless devices and a Near Field Communications (NFC) system 201, e.g., an NFC access point, and/or NFC 204, e.g., an NFC tag. Laptop 210 also has an associated NFC device, e.g., tag, 212. Although system 200 is shown as including computing device 205, the system is not so limited and computing device 205 can be omitted where communication system 202 is a router being connected to the Internet.

Many computer systems and electronic devices manufacturer before 2013 did not include near field communications as part of the integrated communication system. Thus, NFC abilities are added to these systems and devices as an aftermarket add-on. One approach to adding some NFC abilities is to add an NFC tag, e.g., NFC tag 212, to the system or device. Thus, mobile communication device 200 establishes a NFC communication with NFC tag 212, for example, to read data from the NFC tag 212.

FIG. 4(a) depicts a mobile communication device 220 running an appropriate app establishing communications with the NFC device 201. After NFC communications are established, the mobile communication device 220 receives a network code from the NFC device 201.

FIG. 4(b) depicts the mobile communication device 220 receiving laptop information from an NFC tag 212 associated with the laptop 210. The laptop information provides information on how the mobile communication device 220 can communicate with the laptop 210. In a preferred approach, this laptop information provides information regarding the secondary communication channel.

FIG. 5(a) depicts the mobile communication device 220 establishing communications with the laptop 210. The mobile communication device 220 receives data from the NFC tag 212to establish a communication link, e.g., channel, to communicate with the laptop 210 using one or having the option of using a variety of communication channels, which could include NFC, but are more likely to be Bluetooth, Wi-Fi, Wireless USB, or other communication technologies which are available in both the mobile communications device 220 and the laptop 210. Using this second communication channel, the mobile communication device 220 transmits the network code received from the first device 201/204, and communicates it to the laptop 210 via that secondary communication channel.

FIG. 5(b) depicts the laptop 210 establishing communications with the wireless communication system 202. After communications are established, the laptop 210 provides a network code to the communication system 202, thereby allowing the laptop 210 access to the Internet through the computer system 200.

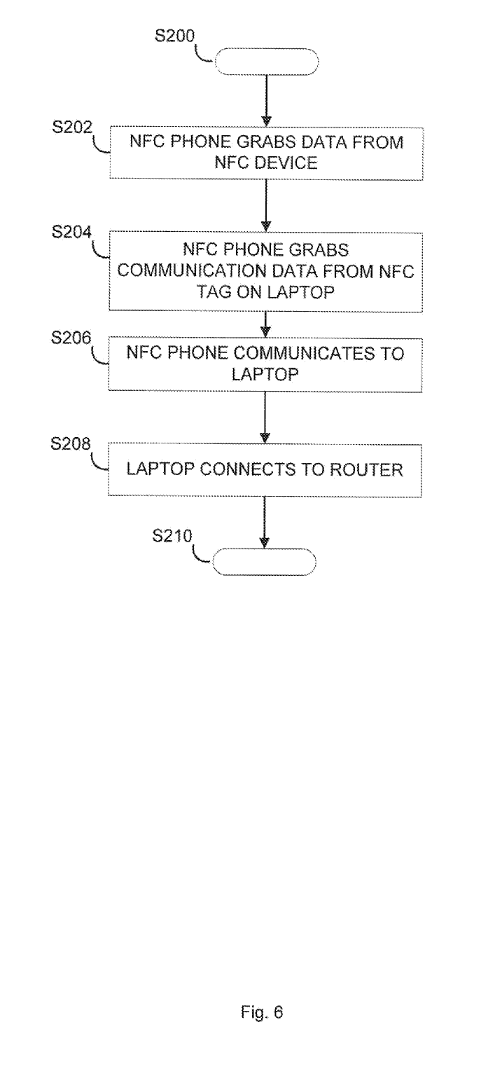

FIG. 6 is a flow chart depicting an exemplary process flow for using the transmission of a code from a first device to a second device by way of a third device. This process flow is based on an exemplary application of the system described with respect to FIGS. 4(a)-(b) and 5(a)-(b).

The process starts at S200 and proceeds to segment S202.

In segment S202, a mobile communication device 220 establishes communications with the NFC device 201. After NFC communications are established, the mobile communication device 220 receives a network code from the NFC device 201. Process continues to segment S204.

In segment S204, the mobile communication device 220 gets laptop communication information from an NFC tag 212 associated, a. g. on, the laptop 210. Process continues to segment S206.

In segment S206, the mobile communication device 220 establishes communications with the laptop 210 using secondary communications channel based on information received from NFC tag 212. After secondary communications are established, the mobile communication device 220 provides a network code to the laptop 210. Process continues to segment S208.

In segment S208, the laptop 210 establishes communications with the wireless communication system 202. After communications are established, the laptop 210 provides a network code to the communication system 202. Process continues to segment S210.

In segment S210, the process is complete and the laptop has access to the Internet.

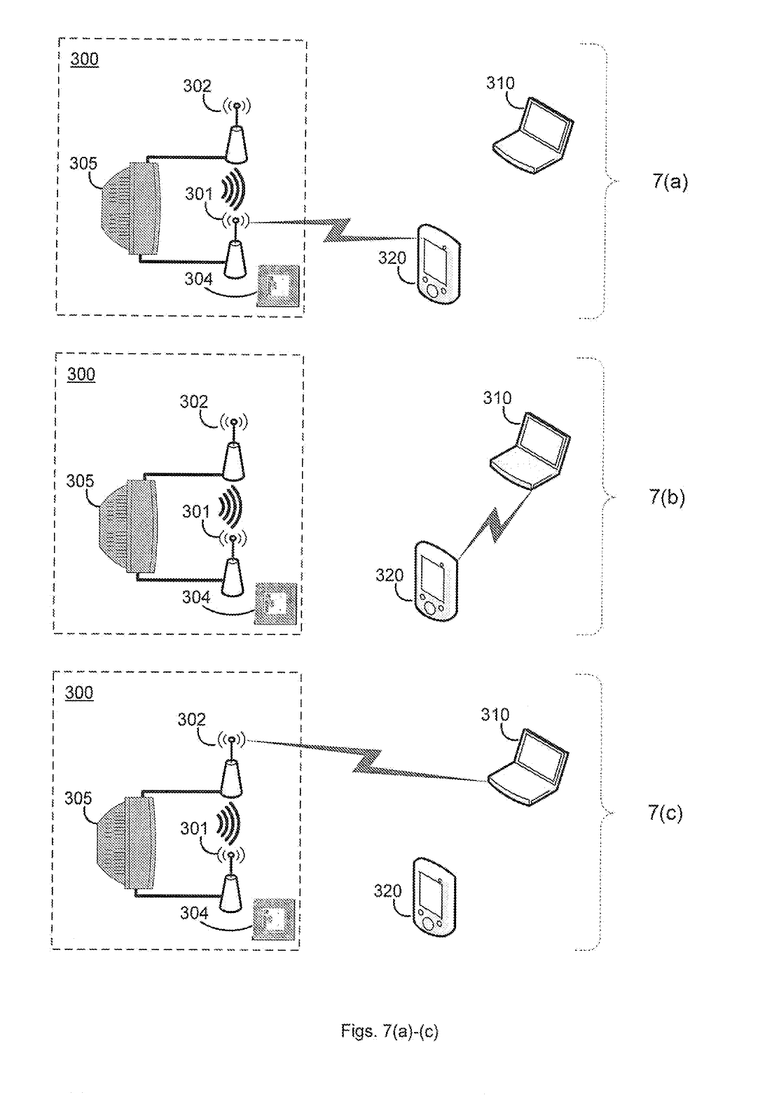

FIGS. 7 (a)-(c) depict a computing device seeking a wireless network connection to a second device in accordance to another exemplary embodiment, where that device may also provide an network connection. FIG. 7(a)-(c) depicts a computing device 310, e.g., a laptop computer, is seeking connection to TV system 300. System 300 includes a television 305, e.g, preferably a “smart” television, a wireless communication system 302 for connecting to other wireless devices and a NFC system 301 and/or NFC 304. Device 302 is a wireless device providing connections to device 305. The system also includes mobile communication device 320 having installed and executing appropriate software to execute the functionality necessary.

FIG. 7(a) depicts an mobile communication device 320 establishing communications with the NFC device 301. After NFC communications are established, the mobile communication device 320 receives access information, e.g., pairing or linking information (PLI), for communicating with device 305 from the NFC device 301/304.

FIG. 7(b) depicts the mobile communication device 320 establishing communications with the NFC laptop 310. After NFC communications are established, the mobile communication, device 320 provides PLI to the laptop 310.

FIG. 7(c) depicts the laptop 310 establishing communications with the wireless communication system 302. After communications are established, the laptop 310 provides a PLI to the communication system 302, thereby allowing the laptop 310 access to the computer system 300, e.g., device 305.

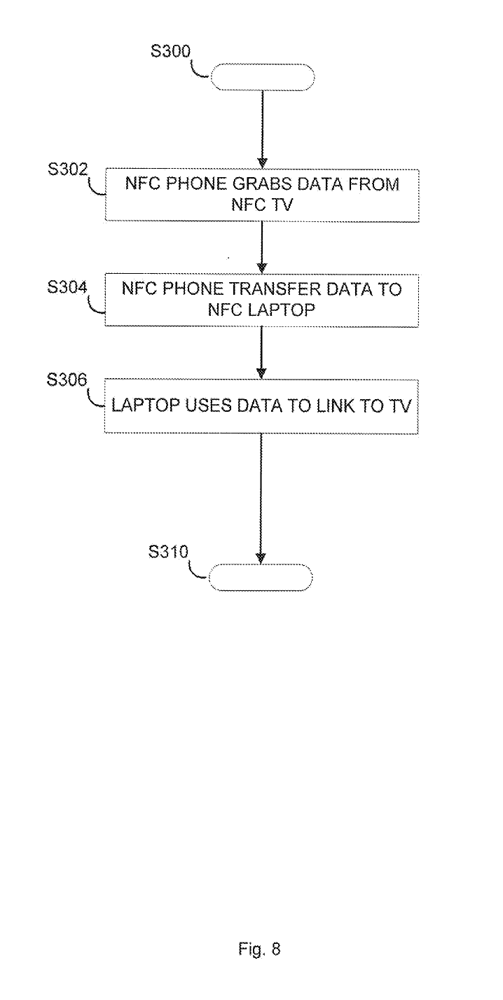

FIG. 8 is a flow chart depicting an exemplary process flow for using the transmission of a code, e.g., PLI, from a first device to a second device and from a second device to a third device thereby enabling the third device access to a first device. This process flow is based on an exemplary application of the system described with respect to FIGS. 7(a)-(c).

The process starts at S300 and proceeds to segment S302.

In segment S302, art mobile communication device 320 establishes communications with the NFC device 301. After NFC communications are established, the mobile communication device 320 receives a PLI from the NFC device 301. Process continues to segment S304.

In segment S304, the mobile communication device 320 establishes communications with the NFC laptop 310. Alter NFC communications are established, the mobile communication device 320 provides PLI to the laptop 310. Process continues to segment S306.

In segment S306, the laptop 310 establishes communications with the wireless communication system 302. After communications are established, the laptop 310 provides the PLI to the communication system 302. Process continues segment S310.

In segment S310, the process is complete and the laptop 310 is now linked or paired to device 305.

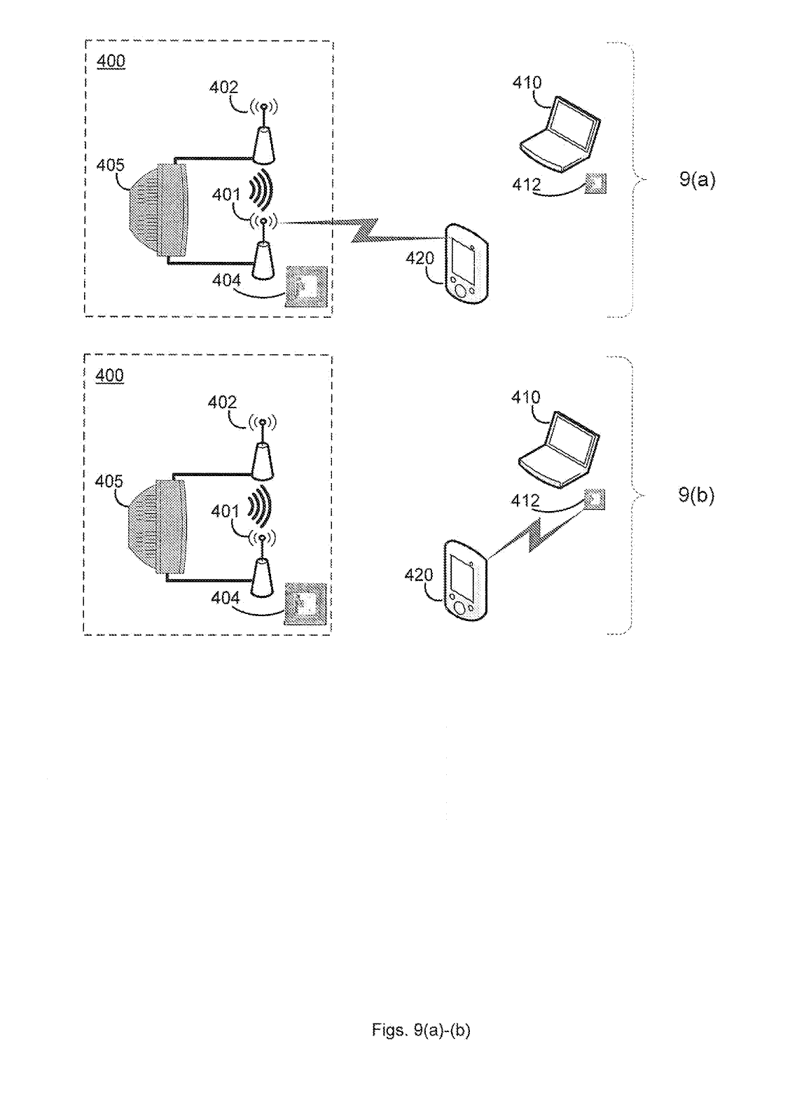

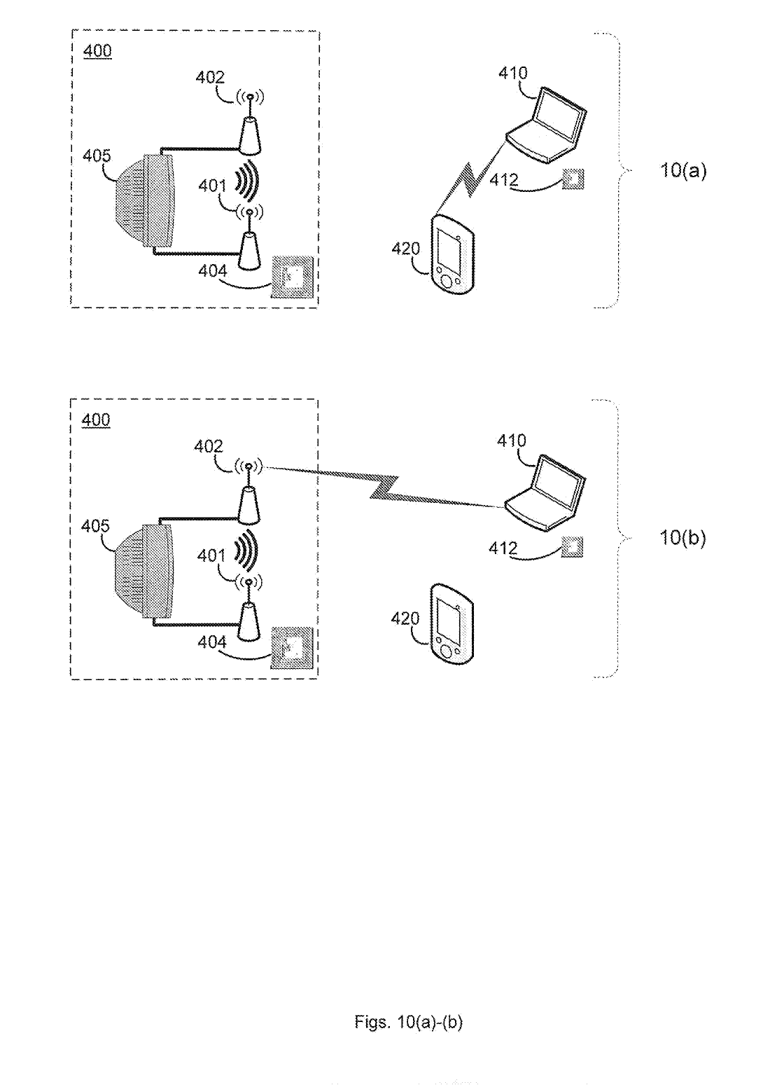

FIGS. 9(a)-(b) and 10(a)-(b) depict example of a computing device seeking a wireless network connection to a second device in accordance to another exemplary embodiment.

FIGS. 9(a)-(b) and 10(a)-(b) depict a computing device 410, e,g., a laptop computer, is seeking connection to TV system 400. System 400 includes a television 405, e.g., preferably a “smart” television, a wireless communication system 402 for connecting to other wireless devices and a NFC system 401 and/or NFC 404. Device 402 is a wireless device providing connections to device 405. Laptop 410 has an associated NFC tag 412.

FIG. 9(a) depicts an mobile communication device 420 establishing communications with the NFC device 401. After NFC communications are established, the mobile communication device 420 receives PLI from the NFC device 401.

FIG. 9(b) depicts that the mobile communication device 400 gets laptop secondary channel communication information from an NFC tag 412 on the laptop 410.

FIG. 10(a) depicts the mobile communication. device 420 establishing communications with the laptop 410 via the secondary communication channel. After secondary communications axe established, the mobile communication device 420 provides a PLI to the laptop 410.

FIG. 10(b) depicts the laptop 410 establishing communications with the wireless communication system 402. After communications are established, the laptop 410 provides the PLI to the communication system 402, thereby allowing the laptop 410 be linked or paired to the TV 405.

Though the above examples refer to a TV, the first device can be any computing item which can allow linking or pairing to a second device. That includes but are not limited to stereos, personal computers, and storage devices.

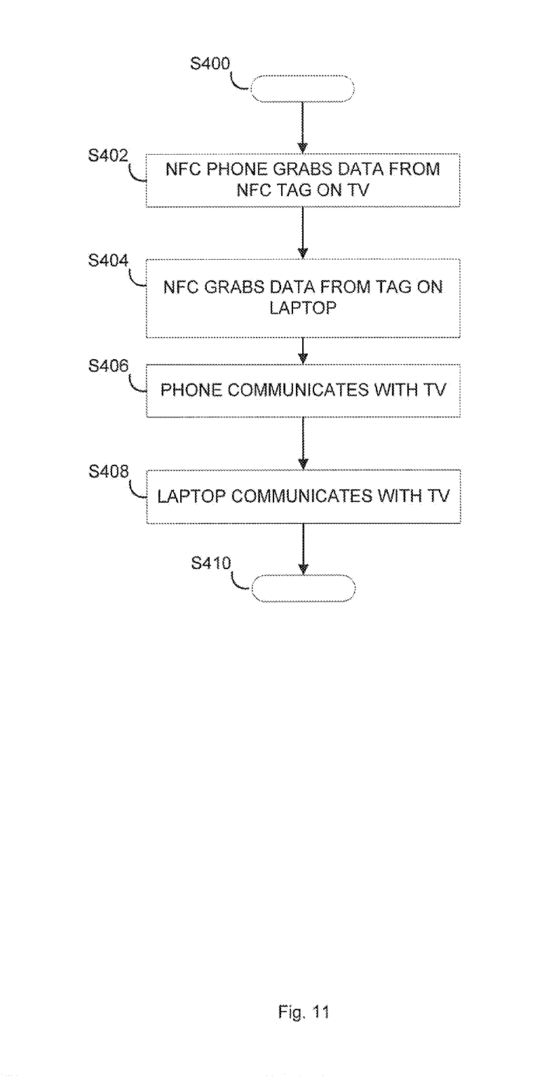

FIG. 11 is a flow chart depicting an exemplary process flow for using the transmission of a code, e.g., PUT, from a first device to a second device and from a second device to a third device thereby enabling the third device access to the first device. Where by second device has a method of communicating indirectly with first device and third device. Using this indirect communication channel, the second device can receive the PLI from the first and third devices. Using the PLI, the second device can then either connect or inform the first and/or third device how to connect and communicate with each other. This process flow is based on an exemplary application of the system described with respect to FIGS. 9(a)-(b) and 10(a)-(b).

The process starts at 3400 and proceeds to segment S402.

In segment S402, an mobile corrununication device 420 establishes communications with the NFC device 401. After NFC communications are established, the mobile communication device 420 receives a PLI from the NFC device 401. Process continues to segment S404.

In segment S404, the mobile communication device 400 gets laptop secondary channel communication information from an NFC tag 412 on the laptop 410. Process continues to segment S406.

In segment s406, the mobile communication device 420 establishes communications with the NFC laptop 410. After NFC communications are establishes, secondary channel communication with laptop and provides a PIA to he laptop 410 via secondary channel. Process continues to segment S408.

In segment S408, the laptop 410 establishes communications with the wireless communication system 402. After communications are established, the laptop 410 provides the PLI to the communication system 402. Process continues to segment S410.

In segment S410, the process is complete and the laptop 410 is able to communicate with the device 405.

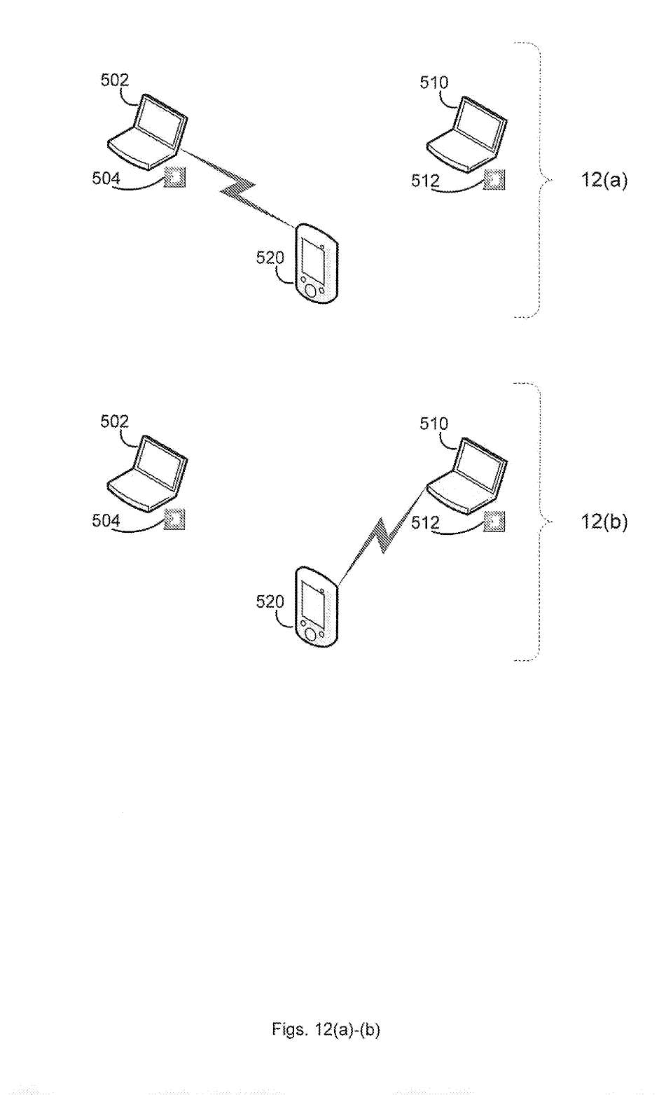

FIGS. 12 (a)-(b) depict a computing device seeking a wireless connection to a second device in accordance to another exemplary embodiment. As depicted in FIG. 12(a)-(b) a computing device 510, e.g., a laptop computer, is seeking connection to a second computing device 502, e.g., a laptop computer. Computing device 502 has an associated NFC tag 504. Computing device 510 has an associated NFC tag 512. The system also includes mobile communication device 520 having installed and executing appropriate software to execute the functionality necessary.

FIG. 12(a) depicts a mobile communication device 520 establishing NFC communications with a laptop 502, After NFC communications are established, the mobile communication device 520 receives an electronic file, e.g., a PLI, from the laptop 502.

FIG. 12(b) depicts the mobile communication device 520 establishing communications with the NFC laptop 510. After NFC communications are established, the mobile communication device 520 provides the electronic file—the electronic file received from laptop 502—to the laptop 510. The electronic file can include linking or pairing information, e.g., PLI, the actual data or file sought to be transferred, or an application for allowing secure linking or pairing.

Thus, information has been transferred from one computing device, e.g, laptop 502, to a second computing device, e.g., laptop 510, using a third computing device, e.g., mobile communication device 520.

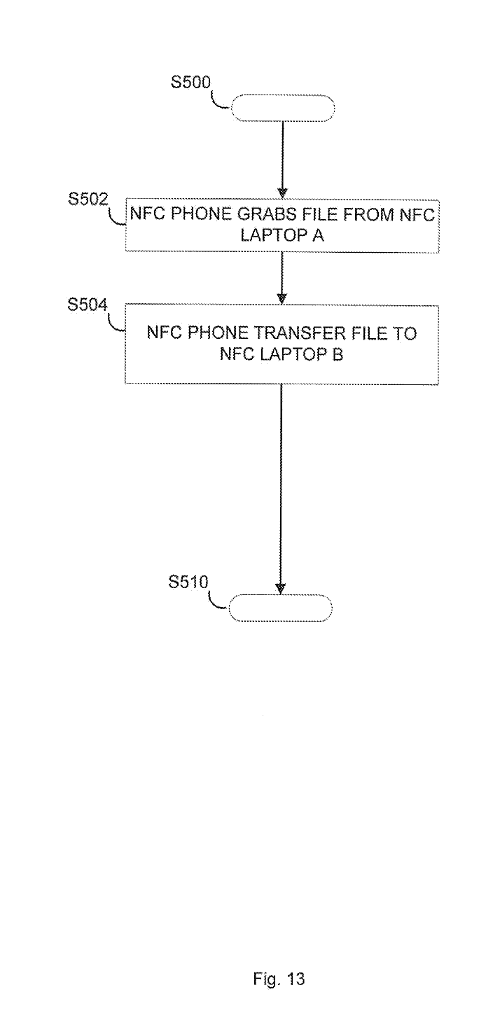

FIG. 13 depicts a flow for using the transmission of an electronic file and is similar to FIGS. 12(a)-(b).

FIG. 13 is a flow chart depicting an exemplary process flow for using the transmission of an electronic data, e.g., PLI, from a first device to an intermediary device and from an intermediary device to a second device. This process flow is based on an exemplary application of the system described with respect to FIGS. 12(a)-(b).

The process starts at S500 and proceeds to segment S502.

In segment S502, an mobile communication device 520 establishes communications with the NFC laptop 502. After NFC communications are established the mobile communication device 520 receives electronic datafrom the NFC device 501. Process continues to segment S504.

In segment S504, the mobile communication device 520 establishes communications with the NFC laptop 510. After NFC communications are established, the mobile communication device 520 provides the electronic data to the laptop 510. Process continues to segment S510.

In segment S510, the process is complete. In a first approach, the second laptop has used the information contained m the electronic file to form a link/pair with the first laptop. In another approach, the second laptop has received data or a file from the first laptop.

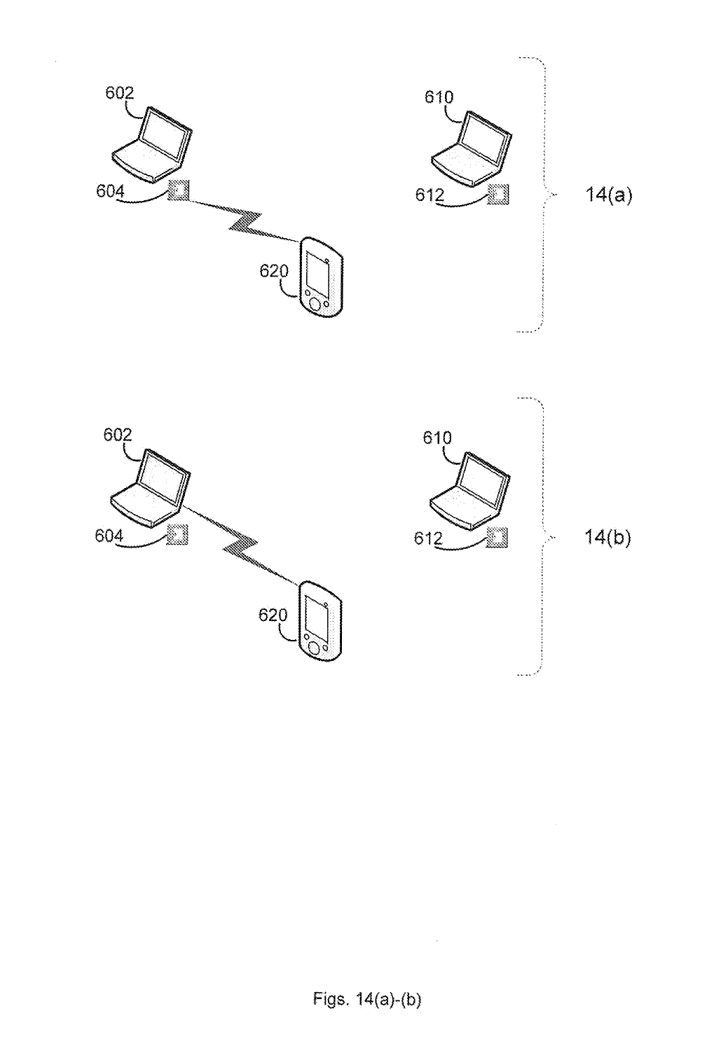

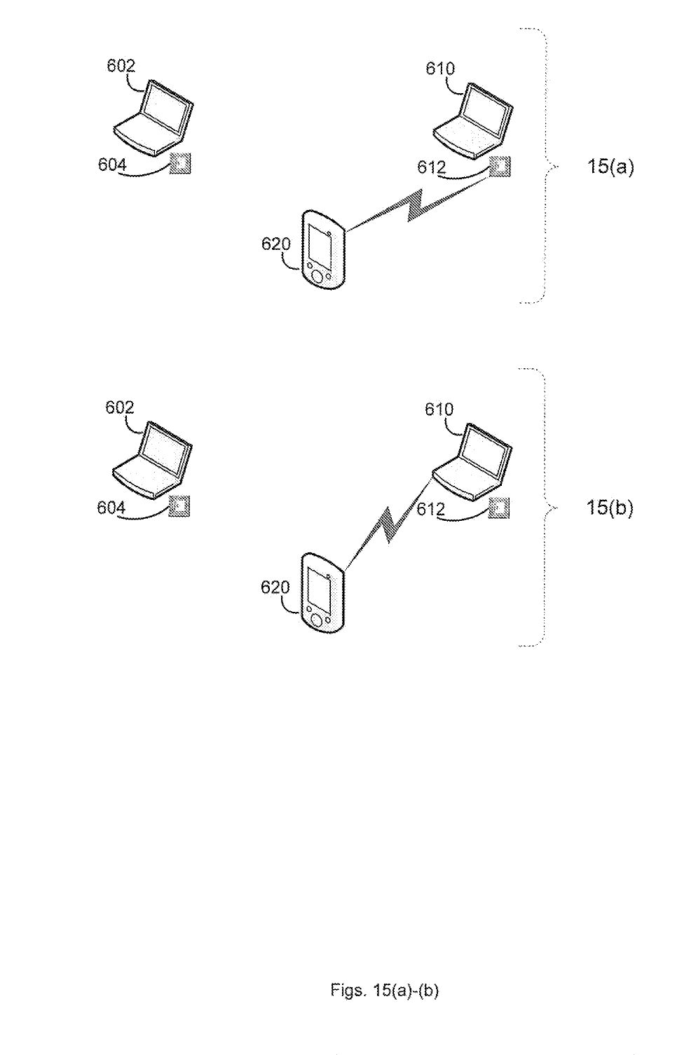

FIGS. 14 (a)-(b) and 15(a)-(b) depict a computing device seeking a wireless network to a second device in accordance to another exemplary embodiment. As depicted in FIG. 14(a)-(b) and 15(a)-(b) a computing device 610, eg., a laptop computer is seeking connection to a second computing device 602, e.g., a laptop computer. Computing device 602 has an associated NFC tag 604. Computing device 610 has an associated NFC tag 612. The system also includes mobile communication device 620 having installed and executing appropriate software to execute the functionality necessary.

FIG. 14(a) depicts an mobile communication device 620 establishing communications with the NFC tag 604 of laptop 602. The mobile communication device 620 receives communication link information.

FIG. 14(b) depicts an mobile communication device 620 establishing communications with the NFC laptop 602 using the communication link information received from NFC tag 604 and receives a file from laptop 602.

FIG. 15(a) depicts an mobile communication device 620 establishing communications with the NFC tag 612 of laptop 610. The mobile communication device 620 receives communication link information,

FIG. 15(b) depicts an mobile communication device 620 establishing communications with the NFC laptop 610 using the communication link information and provides the file received from laptop 602 to laptop 610.

Thus, laptop 610 has been connected with laptop 602 using information received from mobile communication device 620 from laptop 602 and provided to laptop 610.

Although the example above is described with reference to NFC communications, the invention is not limited.

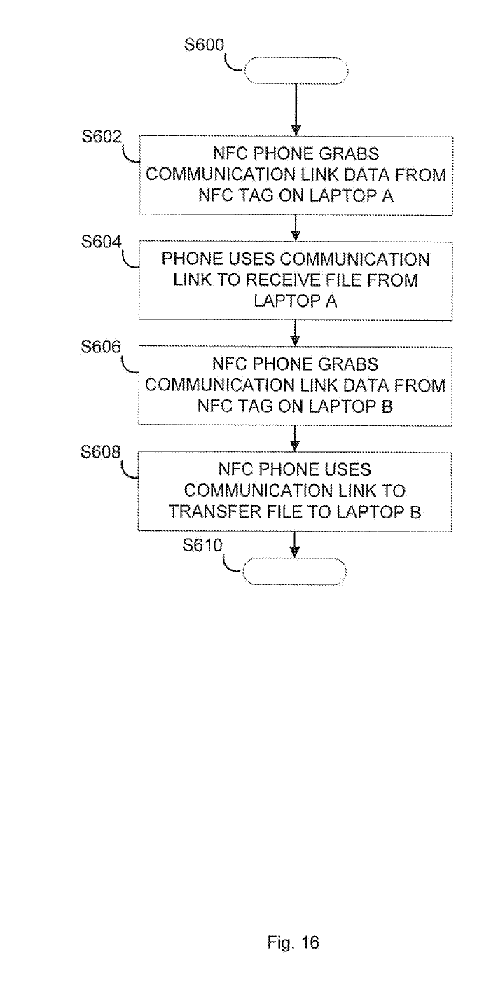

FIG. 16 is a flow chart depicting an exemplary process flow for using the transmission of a information, e.g., a file, from a first device to a second device and from a second device to a third device where by the second device being used to temporarily store and physically move a file from the first device to the third device. This process flow is based on an exemplary application of the system described with respect to FIGS. 14(a)-(b) and 15(a)-(b).

The process starts at 5600 and proceeds to segment S602.

In segment S602, an mobile communication device 620 establishes communications with the tag 604 of the laptop 602 and receives communication link information from NFC tag 604. Process continues to segment S604,

In Segment S604, an mobile communication device 620 establishes communications with the NFC laptop 602 using the communication link information received from NFC tag 604. After NFC communications are established, the mobile communication device 620 receives a file from the NFC device 602. Process continues to segment S606.

In segment S606, mobile communication device 620 establishes communications with the tag 612 of the laptop 610 and receives communication link information Process continues to segment S608.

In segment S608, an mobile communication device 620 establishes communications with the NFC laptop 610 using the communication link information received from NFC tag 612. After NFC communications are established, the mobile communication device 620 provides to the laptop 610 the file it received from the NFC device 602. Process continues to segment S610.

In Segment S610, the process is complete and the second laptop has received the file. The file can include linking or code information or the actual data sought to be transferred.

In another embodiment, the system allows for not only connecting the first and second device, but defining restrictions and allowances for which files, applications, services, and sections that the second device will have access to, once paired or linked to the first device. For example, in the exemplary approach of pairing a laptop to a smart TV using an embodiment of the invention, the linking information includes restrictions/allowances such that the laptop can only send certain file types such as video or audio, restricting the laptop from say sending other file types that the smart tv is able to show such as photos, but the restrictions setup with the linking information would define to the laptop that it can send videos and music to this tv but not photos. Or the restrictions/allowances pertaining to the laptop such that the laptop can send files but are restricted to receiving files from the TV. Furthermore, the restrictions/allowances information can define to the laptop that only certain tile types are able to be played on the tv such as telling the laptop that MP4 files can be played, but not WMV files for video. Any possibly rules and restrictions that are either predefined, dynamically defined, defined at the moment of information transfer, or defined based on circumstances of devices or other time or environmental points, that can define rules, restrictions, instructions, and other such criteria to the second device when communicating to the first device.

In another embodiment, the third device is used to carry linking and pairing information as well as files, applications, plugins, or other, to be installed or transferred to the second device from the first device. These items can be general files, secure tokens, automated security applications such as an access timer, VPN plugins or applications specifically used for communicating with the first device or using that first devices network, and other similar offerings, in certain scenarios, it is not simply that a code is needed to connect a second device to a first device. In some situations, the second device may be required to run a specific application, plugin, or other such components, as well as connection information, where these components being placed or installed in the second device are specifically designed to connect with the first device or used to monitor and control the communication of the first device with the second device as it run in the second device.

In another embodiment, similar to that described above, the first and second devices have an NFC Reader/Writer. The third device is an NFC Tag, Card, Token, or the like, which can be written to and read by art NFC Reader/Writer:. The first device can write the information onto the third device, and then the third device is carried over to the second device where the second device reads the information on the third device, which was written by the first device. In this approach, scenario, there is no coupled communication of NFC for the mobile communication device. So the mobile communication device is literally a pure carrier. For example, an NFC tag can be affix to the mobile communication device. This NFC tag cannot communicate directly with the mobile communication device, since there is no coupled communication, but the NFC tag has a chip with a processor and internal memory. A first device has an NFC reader/writer. The first device can write the data onto the NFC tag affixed to the mobile communication device. Than the user can carry the affixed NFC tag with the information now written into the NFC tag's memory, and then the second device can use its own NFC reader/writer to read the information from the internal memory of the NFC tag affixed to the mobile communication device.

In the exemplary aspects described above, there are several different types of communications that are referred to. With most wireless communications, there is a fundamental level of communications that must occur before any further, e.g., more substantive, communications occur. With respect to Near Field communications (NFC), for example, two NFC devices are placed within a short distance of each other and establish NFC communications through inherent properties of NFC protocols. Once the NFC communications are established—once the devices are “paired”—the NFC devices can then send, receive, and/or share additional information while the NFC communication is maintained. Current NFC protocols are open and do not require a password or passcode to send, receive, and/or share additional information. With respect to Blue-tooth communications, two blue-tooth devices are placed within distance of each other and one of the devices is triggered to look for a second blue-tooth, once found, the first device requires input of a pass code of the second device for pairing to occur between the two devices. With respect to medium range, e.g., WLAN (wireless local area network) communications, communications typically follow 802.11 protocols. WLAN communications are typically the wireless communications used between a laptop and a computer system where the laptop is located. A computer system may or may not require a passcode or pin from a laptop to complete the WLAN connection between the computer system and the laptop. The computer system may require an additional passcode or pin for the laptop to access the Internet through the computer system after the WLAN has been paired.

In some exemplary approaches, data is conveyed from one device to another device possible through an intermediary device. In some instances, the data is used to establish communications between certain devices. In a preferred approach, the contents of the data are dependent on the context and in general in information sufficient to establish communications between two devices. For example, the data is PLI. For example, the data is router information and password. In yet another approach, the data is network information and network access password.

The exemplary approaches above require, as one would reasonably expect, that the various electronic devices, e.g., the mobile communication devices, the laptops, the NFC tags, computer systems, all include, download, or somehow configured with the appropriate software and/or hardware to execute the examples above. The particular configurations are dependent on the device and scenario.

For example, instead of using NFC technology to convey information, other communication technologies can be employed.

Though the invention discusses a wireless network connection, some devices, e.g., a device not being a mobile communication device, can have a wired network connection. Though the invention discusses a laptop as the second device, the second device can be any other computing device that can have a network connection including but not limited to a Blu-ray Player, Video Game Console, PC, Tablet, etc.

While the invention has been described and illustrated with reference to specific exemplary embodiments, it should be understood that many modifications, combinations, and substitutions can be made without departing from the spirit and scope of the invention. For example, an operation described as occurring in software is not necessarily limited to be implemented in software and can be partially, substantially, or completely implemented in hardware. Similarly, an operation described as occurring in hardware is not necessarily limited to be implemented in hardware and can be partially, substantially, or completely implemented in software. Accordingly, the invention is not to be considered as limited by the foregoing description but is only limited by the scope of the claims.

What is claimed as new and desired to be protected by Letters Patent of the United States is:

1. A method for wirelessly electronically connecting a first electronic
device with a second electronic device, comprising the steps of:
wirelessly receiving an electronic file by a mobile communication device from a first electronic device;
wirelessly providing said electronic file by a mobile communication device to a second electronic device;
determining by said second electronic device access information derived from said electronic file; and
communicating by said second electronic device using said access information with said first electronic device.

2. The method of claim 1, where said step of wirelessly receiving an electronic file by said mobile communication device from said first electronic device further comprises:
wirelessly come by said mobile communication device to said first electronic device using close proximity communication.

3. The method of claim 2, where said step of wirelessly receiving an electronic file by said mobile communication device from said first electronic device further comprises:
wirelessly communicating by a mobile communication device to said first electronic device using close proximity communication,
wherein, said electronic file contains information indicating how said mobile communication device can communicate with said first electronic device using non-close proximity communication.

4. The method of claim 2, further comprising the step of:
communicating by said mobile communication device the file provided by said first electronic device, to said second electronic device using close proximity communication.

5. The method of claim 2, wherein said step of communicating by said second electronic device with said first electronic device further comprises:
communicating by said second electronic device using substantially non close proximity communications with said first electronic device.

6. A method for wirelessly electronically coupling a first electronic device with a second electronic device, comprising the steps of
wirelessly receiving a first communication data by a mobile communication device;
communicating by said mobile communication device with the first electronic device using said first communication data;
receiving an electronic file by said mobile communication device from the first electronic device;
wirelessly receiving a second communication data by the mobile communication device;
communicating by said mobile communication device with the second electronic device using said second communication data;
providing said electronic file by said mobile communication device to the second electronic device; and
communicating by said second electronic device with said first electronic device using by said second electronic device information in said electronic file received to establish communications between first electronic device and second electronic device.

7. The method of claim 6, wherein said step of wirelessly receiving said first communication data by said mobile communication device further comprises:
wirelessly receiving said first communication data by said mobile communication device from an electronic device associate with said first electronic device.

8. The method of claim 7, wherein said step of wirelessly receiving said second communication data by said mobile communication device further comprises:
wirelessly receiving said second communication data by said mobile communication device from a second electronic device associate with said second electronic device.

9. The method of claim 7, where said step of communicating by said mobile communication device with the first electronic device further comprises:
communicating by said mobile communication device with the first electronic device using close proximity communication.

10. The method of claim 9, where said step of communicating by said mobile communication device with the second electronic device further comprises:
communicating by said mobile communication device with the second electronic device using close proximity communication,

11. The method of claim 9, where said step of wirelessly receiving said first communication data by said mobile communication device further comprises:
wirelessly receiving said first communication data from an associated electronic device associated with said first electronic device by said mobile communication device.

12. The method of claim 11, where said step of wirelessly receiving said second communication data by said mobile communication device further comprises:
wirelessly receiving said second communication data from a second associated electronic device associated with said second electronic device by said mobile communication device.

13. The method of claim 11, further comprising:
wherein said step of wirelessly receiving said first communication data from an associated electronic device associated with said first electronic device by said mobile communication device further comprises:
wirelessly receiving using a first communications channel said first communication data from an associated electronic device associated with said first electronic device by said mobile communication device,
wherein said first communications channel being different from close proximity communications.

14. The method of claim 11, further comprising:
wherein said step of wirelessly receiving said first communication data from an associated electronic device associated with said first electronic device by said mobile communication device further comprises:
wirelessly receiving using a first communications channel said first communication data from an associated electronic device associated with said first electronic device by said mobile communication device,
wherein said first communications channel being close proximity communication.

15. The method of claim 11, further comprising:
wherein said step of wirelessly receiving said second communication data from an associated electronic device associated with said second electronic device by said mobile communication device further comprises:
wirelessly receiving using a second communications channel said first communication data from an associated electronic device associated with said second electronic device by said mobile communication device,
wherein said second communications channel being different from close proximity communication.

16. The method of claim 13, further comprising:
wherein said step of wirelessly receiving said second communication data from an associated electronic device associated with said second electronic device b said mobile communication device further comprises:
wirelessly receiving using a second communications channel said first communication data from an associated electronic device associated with said second electronic device by said mobile communication device, wherein said second communications channel being close proximity communication.

17. A method for wirelessly transferring an electronic file between a first and second electronic device using a mobile communication device, comprising:
wirelessly receiving data by said mobile communication device from said first electronic device;
temporarily storing said data received from said first electronic device in said mobile communication device; and
wirelessly providing said data temporarily stored in said mobile communication device to second electronic device.

18. The method of claim 17, where said step of wirelessly receiving data by said mobile communication device from said first electronic device further comprises:
wirelessly receiving data by said mobile communication device from said first electronic device using close proximity communication.

19. The method of claim 18, where said step of wirelessly providing said data temporarily stored in said mobile communication device to second electronic device further comprises:
wirelessly providing said data temporarily stored in said mobile communication device to second electronic device using close proximity communication.
